(19) United States
(12) Patent Application Publication
(10) Pub. No.: US 2022/0250101 A1
(43) Pub. Date: Aug. 11, 2022

(54) Disc For Spray Unit

(71) Applicant: BAYER AKTIENGESELLSCHAFT, Leverkusen (DE)

(72) Inventors: Malcolm FAERS, Düsseldorf (DE); Andrew Charles CHAPPLE, Langenfeld (DE)

(21) Appl. No.: 17/628,887

(22) PCT Filed: Jul. 20, 2020
(86) PCT No.: PCT/EP2020/070440

§ 371 Date: Jan. 20, 2022

(30) Foreign Application Priority Data
Jul. 25, 2019 (EP) 19188229.9

(51) Int. Cl. B05B 3/10

(52) U.S. Cl. CPC B05B 3/1007; A01M 7/005

(57) ABSTRACT

The present invention relates to a disc (10) for a spinning disc liquid atomizer. A surface (20) of the disc comprises a plurality of concentric rings (30) having different radii centred on the centre of the disc. A first concentric ring (40) of an adjacent pair of concentric rings has a surface configured to exhibit a first level of adhesion to the liquid. A second concentric ring (50) of the adjacent pair of concentric rings has a surface configured to exhibit a second level of adhesion to the liquid, and wherein the first level of adhesion is less than the second level of adhesion.

### FIELD OF THE INVENTION

The present invention relates to a disc for a spray unit, to a spray unit having such a disc, to a vehicle having at least one disc, and to a vehicle having such a spray unit.

### BACKGROUND OF THE INVENTION

The general background of this invention is the application of herbicides and pesticides to crops. The spray liquid must be atomised. This is typically done using hydraulic nozzles. A more sophisticated approach is to use spinning discs. When a vehicle spraying the herbicide/pesticide is a drone or unmanned aerial vehicle (UAV), the dedicated spray technology needs to be carefully considered because it adds weight and has energy requirements. As such spinning discs have the potential to be effective atomisation systems for drone applications. This is because they have a general low energy requirement for generating droplets, and other components are compatible with battery-powered drones.

In general, spinning disc atomisers have three modes of droplet formation:
1. if the disc is partially loaded, drops are formed individually at the edge of the disc, typically at teeth or serrations normally set into the periphery of the disc, as shown in FIG. 5a;
2. if the disc is loaded close to capacity, ligaments are formed, from which drops are formed along with their satellites, resulting in a bimodal (or broader) distribution of drop sizes, as shown in FIGS. 5b; and
3. if the disc is overloaded, liquid leaves the disc in sheets and atomisation is closer to that of hydraulic nozzles, with a wide distribution of drop sizes and with an increased proportion of smaller droplets than the two previous modes of droplet formation, as shown in FIG. 5c.

Ideally, products should be applied using only the first atomisation process discussed at 1 above. This ensures control over drop size and minimises the formation of fine droplets and/or a wide distribution of droplet sizes. However, this is not easy to accomplish, because the disc diameter, rotational speed or revolutions per minutes (RPM), and the formulation surface tension all tend to influence the atomisation process. Thus, a required droplet size may not be achievable for a required application rate, leading to one or more of: a too broad distribution of droplet sizes, an incorrect application rate, and application at an energy requirement that is too high for sustained operation via a drone. It is to be noted that the problems of a too broad distribution of droplet sizes and an incorrect application rate apply equally to a land based sprayer.

There is a need to address one or more of these problems.

### SUMMARY OF THE INVENTION

It would be advantageous to have improved means for the spraying of liquids such as those containing fertilizers, herbicides and pesticides, such as insecticides.

The object of the present invention is solved with the subject matter of the independent claims, wherein further embodiments are incorporated in the dependent claims. It should be noted that the following described aspects and examples of the invention apply also for the spray unit, the vehicle having one or more spray unit.

In a first aspect, there is provided a disc for a spinning liquid disc atomizer. A surface of the disc comprises a plurality of concentric rings having different radii centred on the centre of the disc. A first concentric ring of an adjacent pair of concentric rings has a surface configured to exhibit a first level of adhesion to the liquid and a second concentric ring of the adjacent pair of concentric rings has a surface configured to exhibit a second level of adhesion to the liquid. The first level of adhesion is less than the second level of adhesion.

In this manner, a disc is provided for a spinning disk liquid atomiser or liquid spray unit, where control of the droplet spectra is provided through changing how the liquid interacts with the surface of the disc as it transits across that surface. This leads to an ability to control the way the liquid breaks up either on the disc or at the periphery of the disc that is different to the normal control effected through rotational speed and/or the flow rate of liquid applied to the spinning disc.

This surface structure leads to the breakup of liquid across the surface into larger and smaller droplets, and where the larger droplets then move faster than smaller droplets. The larger droplets then tend to coalesce with the smaller droplets leading to a more uniform droplet spectra.

Furthermore, the liquid arrives at the edge of the disc in waves, leading to increased loading to the edge of the disc and resulting in larger droplet emission sizes, that are less susceptible to drift caused by air movement, and that can be appropriately sized for transmission of an active ingredient to the plant and/or to an insect/pest on the plant.

Thus, a required droplet size can be provided for a required flow rate, and additionally the droplet size distribution, centred around the required droplet size, can be made narrower.

In this manner, the correct application of active ingredient per plant per unit area of land can be provided, with a droplet size that is sized appropriately for application and/or sized appropriately to mitigate drift of droplets caused by air movement.

In an example, the surface of the disc comprises a centre disc area, wherein a maximum radius of the centre disc area is less than a minimum radius of the plurality of concentric rings.

In an example, the centre disc area has a surface configured to exhibit the second level of adhesion to the liquid.

In this way, it has been found that this helps to maximise the transfer of momentum to the liquid to be sprayed.

In an example, the first concentric ring is adjacent to the centre disc area.

In an example, the plurality of concentric rings comprises three or more concentric rings. The level of adhesion alternates between the first level and second level of adhesion for adjacent concentric rings progressing in an outwards direction.

In an example, a concentric ring adjacent to an outer edge of the disc has a surface configured to exhibit the second level of adhesion to the liquid.

In an example, the first level of adhesion is provided by a hydrophobic surface.

In an example, the second level of adhesion is provided by a hydrophilic surface.

In an example, the first level of adhesion is provided by a surface that is intentionally textured.

In an example, the second level of adhesion is provided by a surface that is intentionally textured.

In an example, an outer edge of the disc comprises serrations.

In a second aspect, there is provided a spray unit, comprising:

an axle;

a disc according to the first aspect; and

a liquid applicator.

The disc is configured to spin about the axle centred on the centre of the disc. The liquid applicator is configured to apply liquid to a surface of the disc.

In a third aspect, there is provided a spray vehicle, comprising at least one disc according to the first aspect.

In a fourth aspect, there is provided a spray vehicle, comprising at least one spray unit according to the second aspect.

Advantageously, the benefits provided by any of the above aspects equally apply to all of the other aspects and vice versa.

The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows schematic setup of an example of a newly developed disc for a spinning liquid disc atomizer;

FIG. 2 shows a schematic setup of an example of a newly developed spray unit;

FIG. 3 shows a schematic setup of an example of a spray vehicle with at least one newly developed disc;

FIG. 4 shows a schematic setup of an example of a spray vehicle with at least one newly developed spray unit;

FIGS. 5a, 5b and 5c show examples of spray droplet distributions from examples of one or more existing discs;

FIG. 6 shows a schematic example of a newly developed disc for a spray unit;

FIG. 7 shows a schematic example of a newly developed disc for a spray unit;

FIG. 8 shows an example of spray droplet distribution from an example an existing disc;

FIG. 9 shows schematic setup of an example of a newly developed disc for a spray unit; and

FIG. 10 shows schematic examples of droplet movement across a surface of a newly developed disc for a spray unit.

### DETAILED DESCRIPTION OF EMBODIMENTS

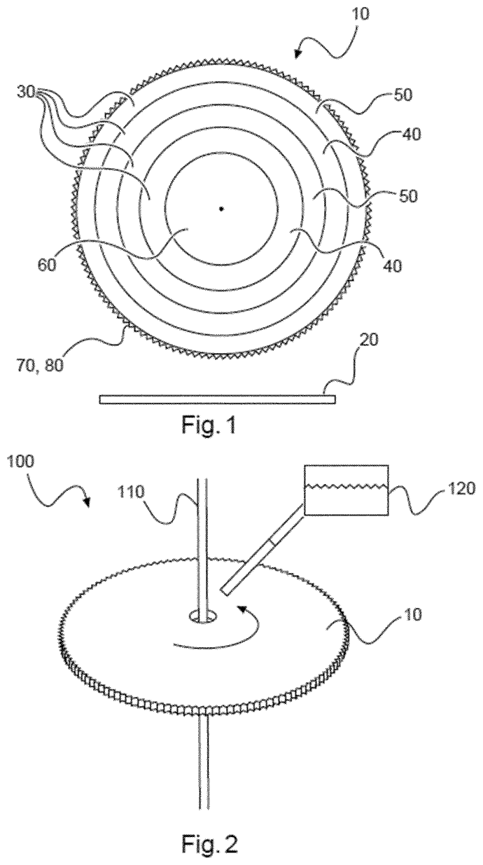

FIG. 1 shows an example of a disc 10 for a spinning disc liquid atomizer. A surface 20 of the disc comprises a plurality of concentric rings 30 having different radii centred on the centre of the disc. A first concentric ring 40 of an adjacent pair of concentric rings has a surface configured to exhibit a first level of adhesion to the liquid and a second concentric ring 50 of the adjacent pair of concentric rings has a surface configured to exhibit a second level of adhesion to the liquid. The first level of adhesion is less than the second level of adhesion.

In this manner, a disc is provided for a spinning disk liquid atomiser or liquid spray unit, where control of the droplet spectra is provided through changing how the liquid interacts with the surface of the disc as it transits across that surface. This leads to an ability to control the way the liquid breaks up either on or at the periphery of the disc that is different to the normal control effected through rotational speed and/or the flow rate of liquid applied to the spinning disc.

This surface structure leads to the breakup of liquid across the surface into larger and smaller droplets, and where the larger droplets then move faster than smaller droplets. The larger droplets then tend to coalesce with the smaller droplets leading to a more uniform droplet spectra.

Furthermore, the liquid arrives at the edge of the disc in waves, leading to increased loading to the edge of the disc and resulting in larger required droplet emission sizes.

Thus, a required droplet size can be provided for a required flow rate, and additionally the droplet size distribution centred around the required droplet size can be made narrower.

In this manner, the correct application of active ingredient per plat per unit area of land can be provided, with a droplet size that is sized appropriately for application and/or sized appropriately to mitigate drift of droplets caused by air movement.

In an example, the first concentric ring 40 of the adjacent pair of concentric rings is contiguous with the second concentric ring 50 of the adjacent pair of concentric rings.

According to an example, the surface of the disc comprises a centre disc area 60 centred on the axle. A maximum radius of the centre disc area is less than a minimum radius of the plurality of concentric rings that are themselves centred on the axle.

According to an example, the centre disc area has a surface configured to exhibit the second level of adhesion to the liquid.

In this way, it has been found that this helps to maximise the transfer of momentum to the liquid to be sprayed.

According to an example, the first concentric ring is adjacent to the centre disc area.

In an example, the first concentric ring is contiguous with the centre disc area

According to an example, the plurality of concentric rings comprises three or more concentric rings. The level of adhesion alternates between the first level and second level of adhesion for adjacent concentric rings progressing in an outwards direction.

In an example, adjacent concentric rings are contiguous with one another.

According to an example, a concentric ring adjacent to an outer edge of the disc has a surface configured to exhibit the second level of adhesion to the liquid.

In an example, the concentric ring adjacent to the outer edge is contiguous with the outer edge.

According to an example, the first level of adhesion is provided by a hydrophobic surface.

According to an example, the second level of adhesion is provided by a hydrophilic surface.

According to an example, the first level of adhesion is provided by a surface that is intentionally textured.

According to an example, the second level of adhesion is provided by a surface that is intentionally textured.

According to an example, an outer edge 70 of the disc comprises serrations 80.

FIG. 2 shows an example of a spray unit 100. The spray unit comprises an axle 110, and a disc 10 as described with respect to FIG. 1. The spray unit also comprises a liquid applicator 120. The disc is configured to spin about the axle centred on the centre of the disc. The liquid applicator is configured to apply liquid to a surface of the disc.

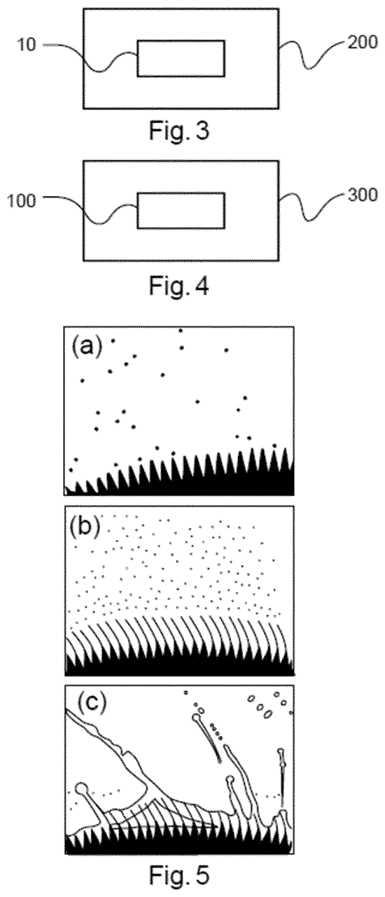

FIG. 3 shows an example of a spray vehicle 200. The spray vehicle comprises at least one disc 10 as described with respect to FIG. 1.

In an example, the vehicle is a drone or UAV.

In an example, the vehicle is a land vehicle.

FIG. 4 shows an example of a spray vehicle 300. The spray vehicle comprises at least one spray unit 100 as described with respect to FIG. 2.

In an example, the vehicle is a drone or UAV.

In an example, the vehicle is a land vehicle.

In an example, the vehicle 300 is the same as vehicle 200. However, in some situations a manufacturer can make vehicle 200 that does not have a liquid applicator 120. For example, in some situations a liquid applicator can be subsequently fitted to the vehicle. Thus, a vehicle can be manufactured as vehicle 200, and then can become vehicle 300 when a liquid applicator is added.

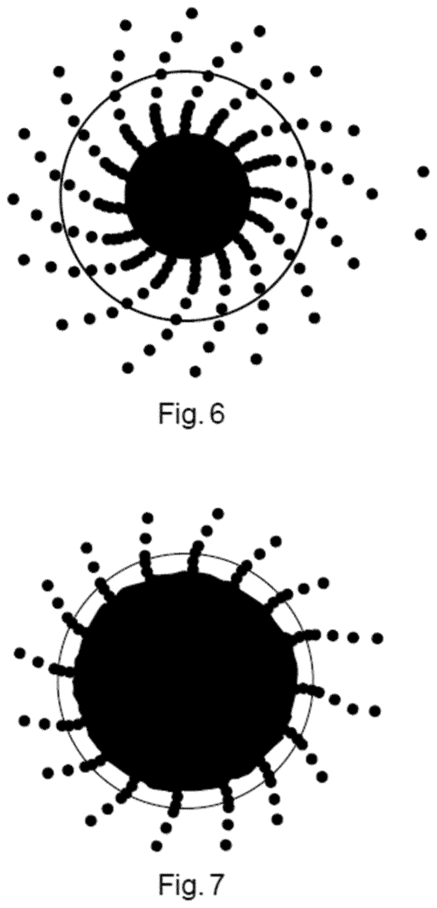

The disc for spray unit, spray unit having such a disc, vehicle having at least one disc, vehicle having such a spray unit are now described in more detail with respect to specific embodiments, where reference is made to FIGS. 6-10, where applicability can be for boom sprayers, UAVs, Unmanned Ground Vehicles (UGV), robotics platforms and back-pack sprayers.

FIG. 6 shows an example of a newly developed disc for a spray unit. The new disc provides for improved droplet atomization through in effect adding another dimension to the atomisation process, namely altering the adhesive properties of the disc, such that the liquid will interact with the disc in different ways at different places on the disc. This alters the way that the liquid breaks up on the disc (partial loading) and/or alters the way that the liquid is presented to the atomisation point (close to maximum loading of disc). This is achieved by the use of, for example, concentric rings of surfaces that alternate between high adhesion with low slip and low adhesion with high slip. This is explained in detail below, but in brief, the central section of the disc contains an area of high adhesion to maximise the transfer of momentum to the spray liquid. This area will also smooth out any variability in the loading of the disc, in a sense mixing and averaging the load. The outer section of the disc contains a series of concentric rings that alternate between high and low adhesion. Assuming that the loading to the disc is relatively low, as depicted in FIG. 6, then as the ligaments of the spray liquid break up into droplets, the droplets will start to separate depending on their size, with the result that the larger droplets will move faster, and will coalesce with any smaller drops produced. A more uniform droplet spectra will result, with the droplets having a more uniform size with less of a spread in sizes. However, as shown in FIG. 7 in the case of near optimal loading of the disc with a high adhesive outermost ring, the liquid presented to the edge of the disc will be arriving in waves. Thus, a higher loading to the edge of the disc can be obtained resulting in larger drops with less variation is droplet size.

The disc surface adhesive properties can be altered in 2-dimensions, or structures can be built up to increase the surface area of the disc. Today, this is typically done using grooves in the disc, or by turning the disc into a cone. However, comb-like structures can be constructed across the surface in place of or augmenting the rings. In this day and age of 3D printing, it is a simple matter to print discs of different plastics and/or surface structures. In 2-dimensions (2D) there are two regimes that can be utilised, smooth and micro-textured surfaces where a surface roughness exists on the micro or nano scale (typically 0.1 mm to 10 nm). In both cases, the surface can be varied between hydrophobic and hydrophilic by changing the surface chemistry. For smooth surfaces, the surface adhesion of a spray liquid (either as a film, ligament or drop) can be changed in this way. For an aqueous liquid, a hydrophilic surface will have a higher adhesion with lower slip, while a hydrophobic surface will have a lower adhesion with higher slip (and vice versa for an oil). However, for smooth surfaces the range of adhesions accessible is not high (as seen by the narrow contact angle range). This range of adhesions (and contact angles) is significantly expanded for micro-textured surfaces, with the result that greater control of the atomisation process is possible (More details are presented in the paper by Bico et al, Wetting of textured surfaces, Colloids and Surfaces A 206 (2002) 41-16).

An example of the benefit of micro-textured surfaces is in concentric rings on a disc as described here. With a smooth surface the effect from concentric rings of high and low adhesion is smaller resulting in a weaker effect on the atomisation process. With a micro-textured surface the effect from concentric rings is greater for regions of high and low adhesion, resulting in an enhanced effect on the atomisation process.

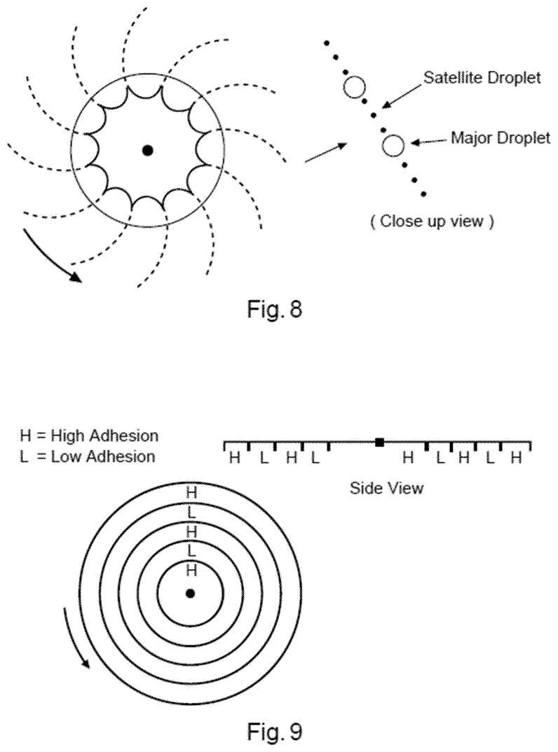

FIG. 8 shows an example of spray droplet distribution from an example an existing disc. Here, as discussed above, due to a disc having a uniform surface droplets form through the break-up of ligaments. This has a disadvantage that satellite droplets, with a smaller size than major droplets, are formed. These smaller droplets are more susceptible to unwanted drift due to air movement.

FIG. 9 shows an example of the newly developed disc for a spray unit. Here, the formation of satellite droplets is mitigated through the use of concentric rings of surfaces that alternate between high adhesion with low slip and low adhesion with high slip. The central section of the disc has an area of high adhesion to maximize the transfer of momentum to the liquid to be sprayed. The outer section of the disc has a series of concentric rings that alternate between low and high adhesion. As the ligaments of the spray liquid break up into droplets, the larger droplets travel at different speeds to the smaller droplets due to the differences in slip between the rings for droplets of different sizes. The result is that the larger droplets catch up with, and coalesce with, the smaller droplets, resulting in a more uniform droplet size with less distribution in sizes, with the spray droplets being centred around a set large size that suffers less from drift.

As discussed above, the surface adhesion can be varied by the use of hydrophilic and hydrophobic regions. Alternately or additionally the surface adhesion can be varied by the use of micro-scale or nano-scale structures.

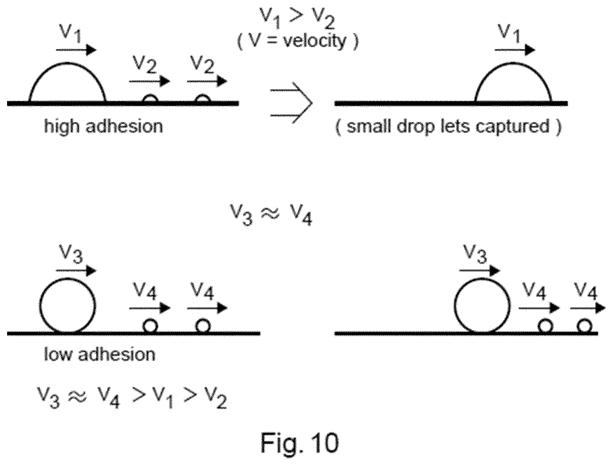

FIG. 10 shows an example of droplet movement across the newly developed disc as it rotates and as liquid is applied. As shown, with high adhesion the smaller droplets acquire a lower relative velocity compared to the larger droplets, leading to the larger droplets capturing the smaller droplets. Furthermore, due to centripetal forces there is a change in velocity of the liquid as the liquid moves outward from the centre of the disc. This causes a break up of the liquid, which is a function of radial distance, radial velocity, and film thickness versus surface tension, and by having a low adhesion concentric ring adjacent to an inner high adhesion area helps to control the break up of the droplets. Also, by having an outer concentric ring at the outer edge of the disc provides for optimum loading of the disc ready for atomization via serrated edges.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

What is claimed is:

1. A disc for a spinning liquid disc atomizer:
wherein, a surface of the disc comprises a plurality of concentric rings having different radii centred on a centre of the disc; and
wherein, a first concentric ring of an adjacent pair of concentric rings has a surface configured to exhibit a first level of adhesion to a liquid and a second concentric ring of the adjacent pair of concentric rings has a surface configured to exhibit a second level of adhesion to the liquid, and wherein the first level of adhesion is less than the second level of adhesion.

2. The disc according to claim 1, wherein the surface of the disc comprises a centre disc area, wherein a maximum radius of the centre disc area is less than a minimum radius of the plurality of concentric rings.

3. The disc according to claim 2, wherein the centre disc area has a surface configured to exhibit the second level of adhesion to the liquid.

4. The disc according to claim 2, wherein the first concentric ring is adjacent to the centre disc area.

5. The disc according to claim 1, wherein the plurality of concentric rings comprises three or more concentric rings, and wherein the level of adhesion alternates between the first level and second level of adhesion for adjacent concentric rings progressing in an outwards direction.

6. The disc according to claim 1, wherein a concentric ring adjacent to an outer edge of the disc has a surface configured to exhibit the second level of adhesion to the liquid.

7. The disc according to claim 1, wherein the first level of adhesion is provided by a hydrophobic surface.

8. The disc according to claim 1, wherein the second level of adhesion is provided by a hydrophilic surface.

9. The disc according to claim 1, wherein the first level of adhesion is provided by a surface that is intentionally textured.

10. The disc according to claim 1, wherein the second level of adhesion is provided by a surface that is intentionally textured.

11. The disc according to claim 1, wherein an outer edge of the disc comprises serrations.

12. A spray unit, comprising:
an axle;
the disc according to claim 1; and
a liquid applicator;
wherein, the disc is configured to spin about the axle centred on the centre of the disc; and
wherein, the liquid applicator is configured to apply the liquid to the surface of the disc.

13. A spray vehicle, comprising at least one disc according to claim 1.

14. A spray vehicle, comprising at least one spray unit according to claim 12.
